(19) United States
(12) Patent Application Publication
(10) Pub. No.: US 2014/0325232 A1
(43) Pub. Date: Oct. 30, 2014

(54) REQUESTING AND STORING CERTIFICATES FOR SECURE CONNECTION VALIDATION

(71) Applicants: Jason C. Schultz, Roseville, MN (US); James R. Heit, Roseville, MN (US); Robert L. Bergerson, Roseville, MN (US)

(72) Inventors: Jason C. Schultz, Roseville, MN (US); James R. Heit, Roseville, MN (US); Robert L. Bergerson, Roseville, MN (US)

(73) Assignee: Unisys Corporation, Blue Bell, PA (US)

(21) Appl. No.: 13/873,472

(22) Filed: Apr. 30, 2013

(51) Int. Cl. H04L 29/06

(52) U.S. Cl. CPC H04L 63/0823
USPC 713/175

(57) ABSTRACT

A client system may be configured to request a certificate from a server system and store the certificate locally. The stored certificate may be used to later authenticate a secure connection between the client system and the server system. The secure connection validated by the stored certificate may be, for example, a secure sockets layer/transport layer security (SSL/TLS) connection.

### FIELD OF THE DISCLOSURE

The instant disclosure relates to computer networks. More specifically, this disclosure relates to communications in computer networks.

### BACKGROUND

Data is frequently transferred over public networks, in which other users of the network have access to the transferred data. These public networks have become ubiquitous with the explosion of Internet-enabled devices. However, data transferred over public networks may often be sensitive data not intended for viewing by a user other than the recipient. Furthermore, the user may specifically desire to prevent other users from viewing the data. Thus, secure connections may be created over the public networks. The secure connections may encrypt the data to ensure that only the intended recipient may view the data. Secure connections may be established through a secure sockets layer/transport layer security (SSL/TLS) protocol with the aid of a certificate. The server communicating with a client may have a SSL/TLS certificate that provides a client with an assurance that the server is the computer the server claims to be. Furthermore, the certificate may include the public key for use by the client to transmit encrypted data to the server.

An SSL/TLS connection cannot be established between two systems, such as a server and a client, without the exchange of the certificate. In order for the connection to be secure, the system that receives the certificate, such as a client, must check whether the certificate is valid. To determine if the certificate is valid, the client system may compare the certificate to a saved list of certificates stored in the client system that were predefined as trusted. Many computer systems will not allow an SSL/TLS connection while acting as a client if the received certificate is not trusted.

FIG. 1 is flow chart illustrating a conventional method for validating a certificate. At block 102, a secure SSL/TLS connection may be initiated by a client system with a server system. At block 104, the client system receives a certificate from the server system. At block 106, the client system compares the certificate with saved server certificates. At block 108, the client system determines whether a match exists between the received certificate and saved certificates. If not, the SSL/TLS secure connection is terminated at block 110. If so, data transfer occurs through the SSL/TLS secure connection.

Conventionally, valid certificates are predefined on the client system. That is, the valid certificates may be manually installed on the client system by an administrator in advance of the client system connecting to a server system. However, manually loading certificates on a client system may be tedious for administrators. Furthermore, when a network configuration changes resulting in access of different server systems by a client system, there is no method for reconfiguring the client system, except through manual attention from an administrator.

### SUMMARY

Certificates may be received through a network connection by a client system and stored locally to modify the list of valid certificates. The user may obtain the certificate from the remote system so that it can be added to the list of trusted certificates. This may be accomplished by allowing an administrator to capture a certificate from a remote system into a file so that the certificate for the server can be added to the list of trusted certificates.

According to one embodiment, a method may include establishing a connection with a server. The method may also include requesting a certificate from the server. The method may further include receiving the certificate from the server. The method may also include initiating a secure connection with the server based, at least in part, on the certificate.

According to another embodiment, a computer program product may include a non-transitory computer readable medium comprising code to perform the steps of establishing a connection with a server, requesting a certificate from the server, receiving the certificate from the server, and initiating a secure connection with the server based, at least in part, on the certificate.

According to a further embodiment, an apparatus may include a memory, and a processor coupled to the memory. The processor may be configured to execute the steps of establishing a connection with a server, requesting a certificate from the server, receiving the certificate from the server, and initiating a secure connection with the server based, at least in part, on the certificate.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is flow chart illustrating a conventional method for validating a certificate.

FIG. 2 is a flow chart illustrating a method for loading certificates on a client system according to one embodiment of the disclosure.

FIG. 3 is a terminal prompt illustrating user input for, and client system terminal output of, activating the method for loading certificates on a client system according to one embodiment.

FIG. 4 is a call diagram illustrating actions following receiving a command from an emulated environment to request a certificate according to one embodiment of the disclosure.

FIG. 5 is a block diagram illustrating a computer network according to one embodiment of the disclosure.

FIG. 6 is a block diagram illustrating a computer system according to one embodiment of the disclosure.

FIG. 7A is a block diagram illustrating a server hosting an emulated software environment for virtualization according to one embodiment of the disclosure.

FIG. 7B is a block diagram illustrating a server hosting an emulated hardware environment according to one embodiment of the disclosure.

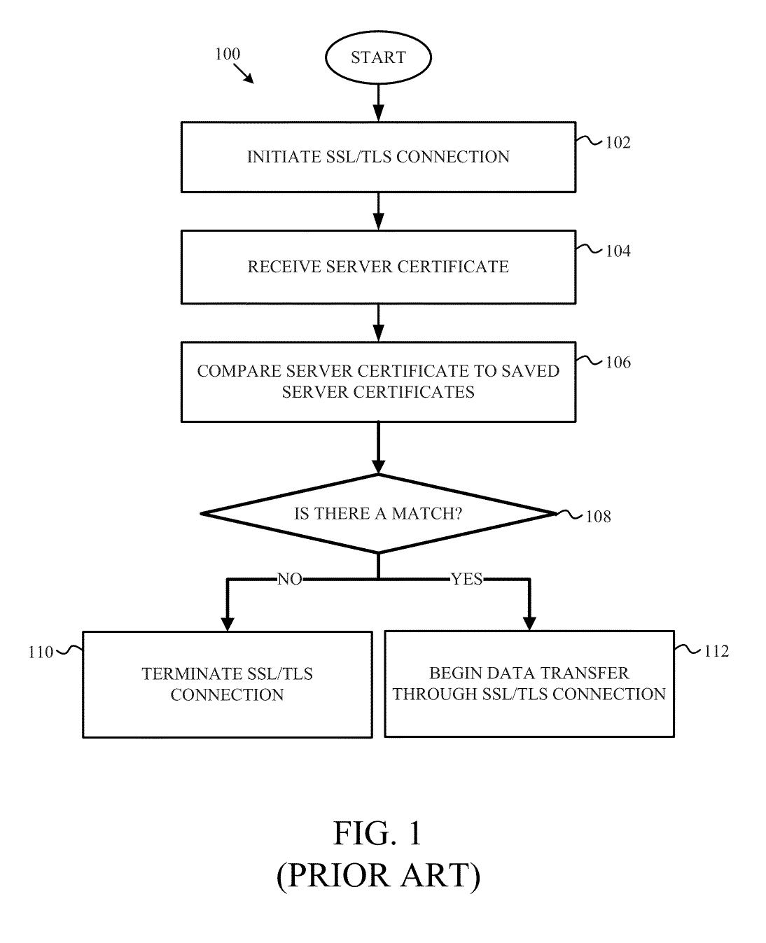

### DETAILED DESCRIPTION

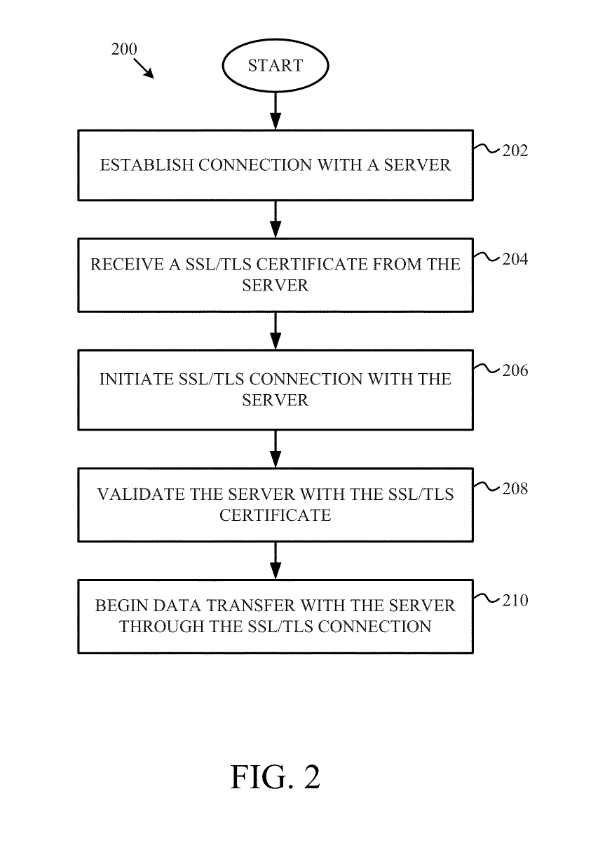

FIG. 2 is a flow chart illustrating a method for loading certificates on a client system according to one embodiment of the disclosure. A method 200 begins at block 202 with establishing, by a client system, a connection with a server system. The connection of block 202 may be an unsecure connection. At block 204, a certificate, such as a SSL/TLS certificate, may be received from the server system. The certificate may be requested by the client system after establishing a connection with the server system. The certificate may be stored locally to be used during later validation of a secure connection with the server.

At block 206, a secure connection, such as a SSL/TLS connection, may be initiated with the server. At block 208, the server may be validated based on the received certificate. For example, the client system may request a certificate from the server system during initiation of the SSL/TLS connection. The client system may validate the certificate by comparing the certificate to previously-stored certificates, such as the certificate received at block 204. When the server is validated, data transfer with the server through the secure connection may take place at block 210.

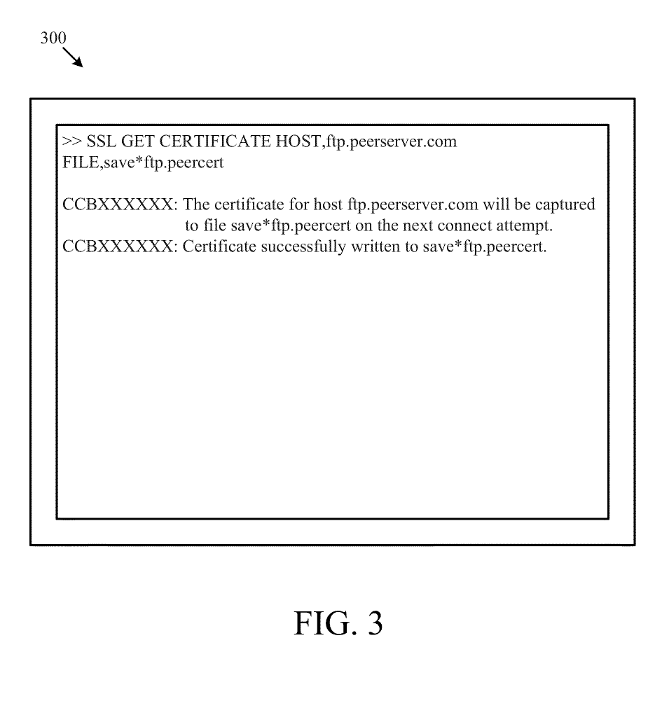

FIG. 3 is a terminal prompt illustrating user input for, and client system terminal output of, activating the method for loading certificates on a client system according to one embodiment. A command may be entered on a terminal 300 to initiate the fetching of a certificate from a server. The command format may be:

```
SSL GET CERTIFICATE HOST,{ip-address or domain name};
        FILE,filename[.elt];
        [PORT,port-number].
```

HOST,{IP-address|host name} may identify the target host to capture the certificate from. The host may be identified by the domain name of the host, specified by an alphanumeric string of fewer than 255 characters, consisting of one or more labels separated by periods, or by the IPv4 or IPv6 address of the host. FILE,filename[.elementname] may specify the file name or file and element names where the certificate should be stored. If the file already contains text, the fetched certificate may be appended to the existing file. If the file does not exist, the file may be created. PORT,port-number may specify a decimal number of the port that the SSL/TLS handshake will attempt to fetch the certificate from. By specifying this field the certificate capture can be targeted to a specific application. If this field is omitted, any SSL/TLS handshake to the specified host will have its certificate captured. An example command may be “SSL GET CERTIFICATE HOST,ftp.peerserver.com FILE,save*ftp.peercert.” An example response to the command is shown in FIG. 3.

If the command passes syntax and setup tests, a new event will be sent to an application, such as a SSL/TLS service, with the processed information. This information will be saved to a new get certificate table. There may be a chain of get certificate tables allowing for an unbounded number of tables. When a certificate is received as part of a handshake the get certificate table chain may be checked to determine if the handshake is occurring with a defined remote system. If so, the certificate may be saved in PEM format with a .PEM extension to the etc/ssl/certs directory, which is the location for trusted certificates, and the handshake terminated. The get certificate table may also be discarded.

When the command is issued from an emulated environment, an interface, such as XNIOP, may send a get certificate command translation packet to the requesting program in the emulated environment, such as CPCommOS, indicating the certificate has been saved. The program may display a message to indicate the certificate has been saved. The user may then issue an SSL UPDATE TRUST command to update trust. If a handshake is then attempted with the remote host it will not fail for trust reasons.

If a peer system presents a certificate that is not trusted, this feature allows a copy of this certificate to be retrieved so that it can be added to a trusted certificates file. This action may be performed without requiring the administrator of the peer system to provide the certificate.

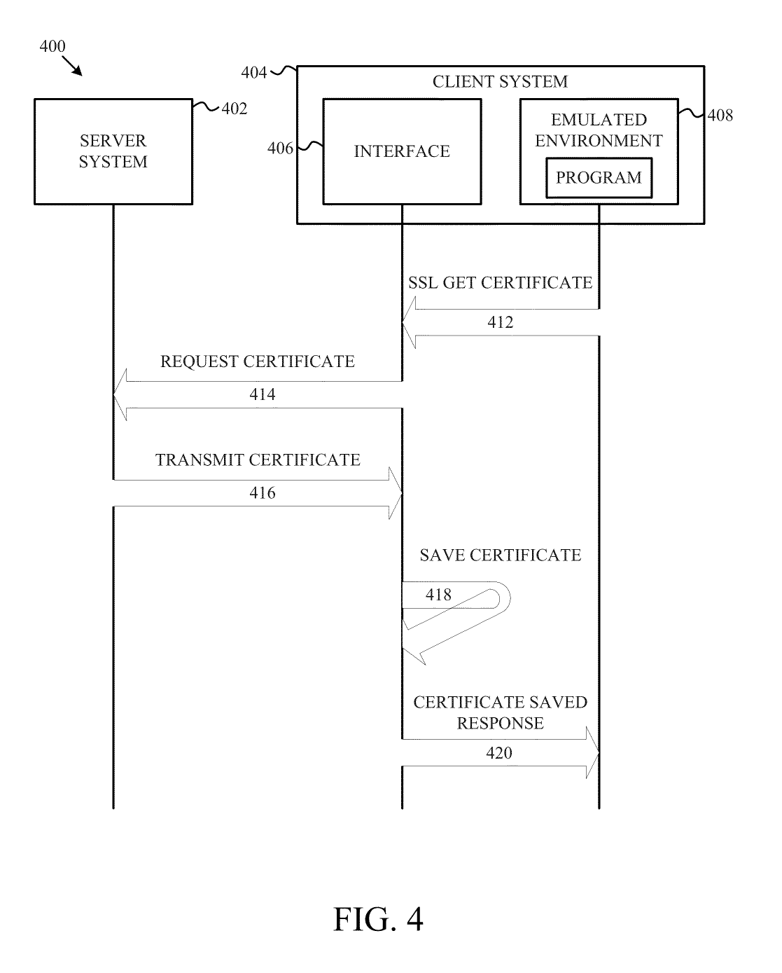

FIG. 4 is a call diagram illustrating actions following receiving a command from an emulated environment to request a certificate according to one embodiment of the disclosure. A server system 402 may communicate with a client system 404, having an interface 406 and an emulated environment 408. A program may be executed in the emulated environment 408 for receiving and processing user commands.

At call 412, a SSL GET CERTIFICATE command is received in the emulated environment 408. The emulated environment 408 passes the request to the interface 406. The interface 406 then requests a certificate from the server system 402 at call 414. At call 416, the server system 402 responds with the certificate. At call 418, the interface 406 stores the certificate within the client system 404. At call 420, the interface 406 indicates to the emulated environment 408 that the certificate is saved in the client system 404. Future requests for secure connections to the server system 402 by programs within the emulated environment 408 may be initiated by validating the server system 402 based on the saved certificate of call 418.

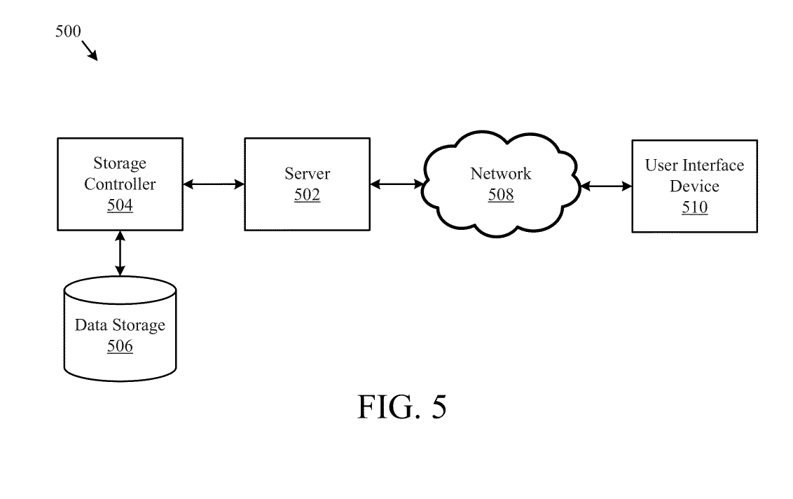

FIG. 5 illustrates one embodiment of a system 500 for an information system, including a system for transferring certificates. The system 500 may include a server 502, a data storage device 506, a network 508, and a user interface device 510. The server 502 may also be a hypervisor-based system executing one or more guest partitions hosting operating systems with modules having server configuration information. In a further embodiment, the system 500 may include a storage controller 504, or a storage server configured to manage data communications between the data storage device 506 and the server 502 or other components in communication with the network 508. In an alternative embodiment, the storage controller 504 may be coupled to the network 508.

In one embodiment, the user interface device 510 is referred to broadly and is intended to encompass a suitable processor-based device such as a desktop computer, a laptop computer, a personal digital assistant (PDA) or tablet computer, a smartphone or other mobile communication device having access to the network 508. When the device 510 is a mobile device, sensors (not shown), such as a camera or accelerometer, may be embedded in the device 510. When the device 510 is a desktop computer the sensors may be embedded in an attachment (not shown) to the device 510. In a further embodiment, the user interface device 510 may access the Internet or other wide area or local area network to access a web application or web service hosted by the server 502 and may provide a user interface for enabling a user to enter or receive information.

The network 508 may facilitate communications of data between the server 502 and the user interface device 510. The network 508 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

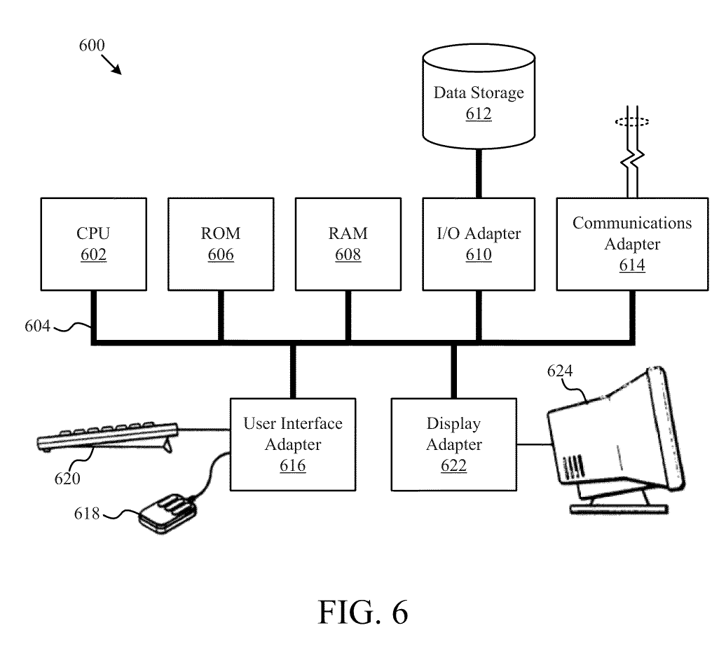

FIG. 6 illustrates a computer system 600 adapted according to certain embodiments of the server 502 and/or the user interface device 510. The central processing unit (“CPU”) 602 is coupled to the system bus 604. The CPU 602 may be a general purpose CPU or microprocessor, graphics processing unit (“GPU”), and/or microcontroller. The present embodiments are not restricted by the architecture of the CPU 602 so long as the CPU 602, whether directly or indirectly, supports the operations as described herein. The CPU 602 may execute the various logical instructions according to the present embodiments.

The computer system 600 also may include random access memory (RAM) 608, which may be synchronous RAM (SRAM), dynamic RAM (DRAM), synchronous dynamic RAM (SDRAM), or the like. The computer system 600 may utilize RAM 608 to store the various data structures used by a software application. The computer system 600 may also include read only memory (ROM) 606 which may be PROM, EPROM, EEPROM, optical storage, or the like. The ROM may store configuration information for booting the computer system 600. The RAM 608 and the ROM 606 hold user and system data, and both the RAM 608 and the ROM 606 may be randomly accessed.

The computer system 600 may also include an input/output (I/O) adapter 610, a communications adapter 614, a user interface adapter 616, and a display adapter 622. The I/O adapter 610 and/or the user interface adapter 616 may, in certain embodiments, enable a user to interact with the computer system 600. In a further embodiment, the display adapter 622 may display a graphical user interface (GUI) associated with a software or web-based application on a display device 624, such as a monitor or touch screen.

The I/O adapter 610 may couple one or more storage devices 612, such as one or more of a hard drive, a solid state storage device, a flash drive, a compact disc (CD) drive, a floppy disk drive, and a tape drive, to the computer system 600. According to one embodiment, the data storage 612 may be a separate server coupled to the computer system 600 through a network connection to the I/O adapter 610. The communications adapter 614 may be adapted to couple the computer system 600 to the network 508, which may be one or more of a LAN, WAN, and/or the Internet. The user interface adapter 616 couples user input devices, such as a keyboard 620, a pointing device 618, and/or a touch screen (not shown) to the computer system 600. The display adapter 622 may be driven by the CPU 602 to control the display on the display device 624. Any of the devices 602-622 may be physical and/or logical.

The applications of the present disclosure are not limited to the architecture of computer system 600. Rather the computer system 600 is provided as an example of one type of computing device that may be adapted to perform the functions of the server 502 and/or the user interface device 510. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 600 may be virtualized for access by multiple users and/or applications.

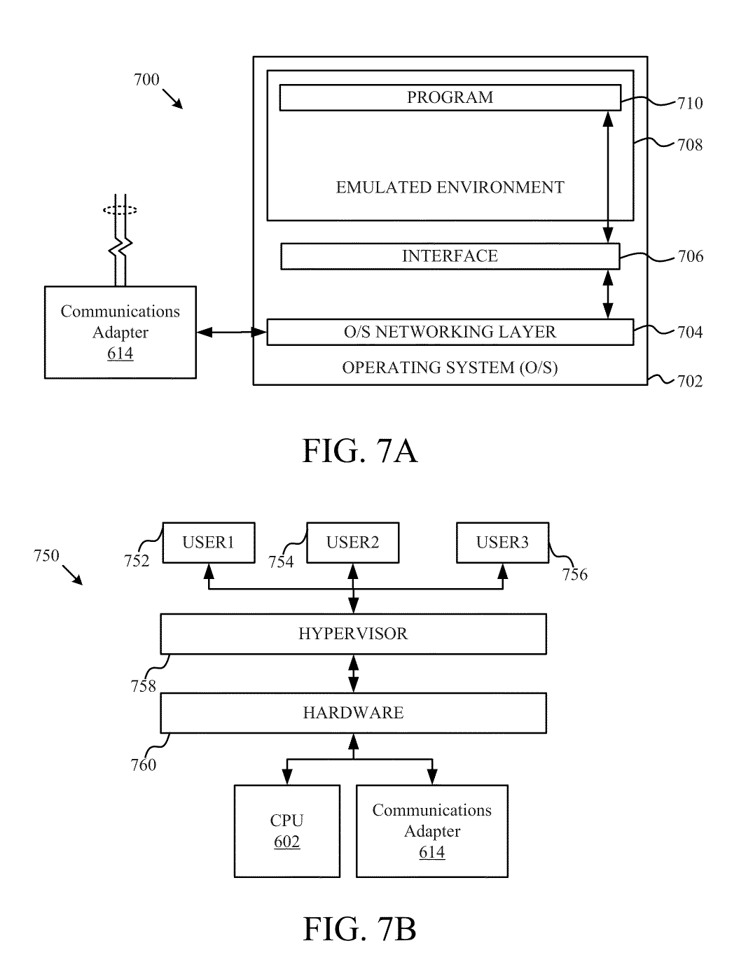

FIG. 7A is a block diagram illustrating a server hosting an emulated software environment for virtualization according to one embodiment of the disclosure. An operating system 702 executing on a server includes drivers for accessing hardware components, such as a networking layer 704 for accessing the communications adapter 714. The operating system 702 may be, for example, Linux. An emulated environment 708 in the operating system 702 executes a program 710, such as CPCommOS. The program 710 accesses the networking layer 704 of the operating system 702 through a non-emulated interface 706, such as XNIOP. The non-emulated interface 706 translates requests from the program 710 executing in the emulated environment 708 for the networking layer 704 of the operating system 702.

In another example, hardware in a computer system may be virtualized through a hypervisor. FIG. 7B is a block diagram illustrating a server hosing an emulated hardware environment according to one embodiment of the disclosure. Users 752, 754, 756 may access the hardware 760 through a hypervisor 758. The hypervisor 758 may be integrated with the hardware 760 to provide virtualization of the hardware 760 without an operating system, such as in the configuration illustrated in FIG. 7A. The hypervisor 758 may provide access to the hardware 760, including the CPU 602 and the communications adaptor 614.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
establishing a connection with a server;
requesting a certificate from the server;
receiving the certificate from the server; and
initiating a secure connection with the server based, at least in part, on the certificate.

2. The method of claim 1, further comprising storing the certificate in a certificate store after receiving the certificate.

3. The method of claim 2, in which the step of initiating the secure connection comprises validating the server based, at least in part, on the certificate.

4. The method of claim 3, in which the step of validating the server comprises:
requesting a second certificate from the server; and
comparing the second certificate with certificates in the certificate store.

5. The method of claim 3, further comprising transferring data to the server through the secure connection.

6. The method of claim 1, in which the certificate comprises a secure socket layer/transport layer security (SSL/TLS) certificate.

7. The method of claim 1, in which the step of requesting the certificate from the server comprises:
receiving, from an emulated environment, a command from a user to get the certificate; and
transmitting, from an interface in communication with the emulated environment, a request for the certificate.

8. A computer program product, comprising:
a non-transitory computer readable medium comprising code to perform the steps of:
establishing a connection with a server;
requesting a certificate from the server;
receiving the certificate from the server; and
initiating a secure connection with the server based, at least in part, on the certificate.

9. The computer program product of claim 8, in which the medium further comprises code to perform the step of storing the certificate in a certificate store after receiving the certificate.

10. The computer program product of claim 9, in which the medium further comprises code to perform the step of validating the server based, at least in part, on the certificate.

11. The computer program product of claim 10, in which the medium further comprises code to perform the steps of:
requesting a second certificate from the server; and
comparing the second certificate with certificates in the certificate store.

12. The computer program product of claim 10, in which the medium further comprises code to perform the step of transferring data to the server through the secure connection.

13. The computer program product of claim 10, in which the certificate comprises a secure socket layer/transport layer security (SSL/TLS) certificate.

14. The computer program product of claim 10, in which the medium further comprises code to perform the steps of:
receiving, from an emulated environment, a command from a user to get the certificate; and
transmitting, from an interface in communication with the emulated environment, a request for the certificate.

15. An apparatus, comprising:
a memory; and
a processor coupled to the memory, the processor configured to execute the steps of:
establishing a connection with a server;
requesting a certificate from the server;
receiving the certificate from the server; and
initiating a secure connection with the server based, at least in part, on the certificate.

16. The apparatus of claim 15, in which the processor is further configured to perform the step of storing the certificate in a certificate store of the memory after receiving the certificate.

17. The apparatus of claim 15, in which the certificate comprises a secure socket layer/transport layer security (SSL/TLS) certificate.

18. The apparatus of claim 15, in which the processor is further configured to perform the step of validating the server based, at least in part, on the certificate.

19. The apparatus of claim 18, in which the processor is further configured to perform the steps of:
requesting a second certificate from the server during validation of the server; and
comparing the second certificate with certificates in the certificate store to validate the server.

20. The apparatus of claim 15, in which the processor is further configured to perform the step of transferring data to the server through the secure connection.
